(19) United States
(12) Patent Application Publication
(10) Pub. No.: US 2022/0184958 A1
(43) Pub. Date: Jun. 16, 2022

(54) CLEANING METHOD FOR INK JET IMAGING DEVICE

(71) Applicant: Canon Production Printing Holding B.V., Venlo (NL)

(72) Inventors: Ludovicus M. HEIJNDERS, Venlo (NL); Joop C. SCHEP, Venlo (NL); Guido J.M. LEJEUNE, Venlo (NL)

(73) Assignee: Canon Production Printing Holding B.V., Venlo (NL)

(21) Appl. No.: 17/543,289

(22) Filed: Dec. 6, 2021

(30) Foreign Application Priority Data
Dec. 14, 2020 (EP) 20213931.7

(51) Int. Cl. B41J 2/165; B41J 2/045

(52) U.S. Cl. CPC B41J 2/16526; B41J 2/04596; B41J 2/04581

(57) ABSTRACT

A method for cleaning an ink jet imaging device, the ink jet imaging device including a main ink supply channel including an entrance side for supplying ink, a first ink channel including a first pressure chamber fluidly connected to a first nozzle; a first actuator associated with the first pressure chamber, the first ink channel being in fluid connection with the main ink supply channel and defining a first ink path from the entrance side of the main ink supply channel to the first nozzle and having a first length L1; a second ink channel including a second pressure chamber fluidly connected to a second nozzle; and a second actuator associated with the second pressure chamber, the second ink channel being in fluid connection with the main ink supply channel and defining a second ink path from the entrance side of the main ink supply channel to the second nozzle and having a second length L2, wherein L2>L1. The method includes purging ink through the first and the second nozzle by applying a pressure on the entrance side of the main ink supply channel; and simultaneously actuating the first ink channel by applying a first actuation pulse to the first actuator wherein the actuation pulse provides a pressure wave in the first ink channel that counteracts the local pressure in the first ink channel, such that the flow through the first ink channel is reduced during purging.

### FIELD OF THE INVENTION

The present invention relates to a cleaning method for an ink jet imaging device.

### BACKGROUND ART

Ink in an imaging device is prone to ageing inside the imaging device, in particular in or in the direct vicinity of one or more nozzle openings of the imaging device where the ink is in direct contact with ambient air. Due to ageing of the ink composition, the properties of the ink change such that droplet formation (in particular upon starting of printing after an idle period) is impaired or even impossible.

Methods for cleaning an ink jet imaging device are known from the art, also as ink jet maintenance methods. A well-known technique for cleaning an ink jet imaging device is flushing the imaging device with ink (or other liquid), in particular after a long idle time of the imaging device. A pressure is applied to the ink feed side of the imaging device and the ink is pressed through the nozzle openings of the imaging device and caught in a waste container. This method is also known as purging. Purging can be combined with a wiping action afterwards, for wiping excess liquid (e.g. ink or cleaning liquid or any other jetting fluid) from the nozzle surface. Purging ink through an imaging device (print head) is therefore known in the art for refreshing ink in the imaging device by flushing out aged ink.

A maintenance purge of ink is often used in ink jet print systems to bring nozzles in the right condition to jet perfect droplets right at the start of a print job. The effectiveness of the purge for a particular nozzle is dependent on the ink supply channel of that nozzle, in particular the length of the ink supply channel.

A known configuration of an ink supply channel is a common main supply channel which is supplying multiple nozzles with ink. Such common main supply channel may be fed with ink at one side or at both sides. In either case refreshing the ink in the nozzles by applying a purge of ink, the nozzles close to the feed end side or sides of the common main supply channel will be (completely) refreshed sooner (due to a relatively short ink path) and more thoroughly, because of their location. Nozzles near the end (in case of single side feed) or in the middle (in case of both side feed) of the common main supply channel will take much more time to reach a refreshed state, because these nozzles have the longest ink path in the respective configurations. Due to the low refreshment rate at the end or the middle of the print head, purging needs to be continued until the nozzles at the end or the middle of the print head are also (completely) refreshed.

A disadvantage of this is that purging in this way results in unnecessary purging of ink through the other nozzles with a shorter ink path, which results in excessive ink waste and longer maintenance times, hence in higher running costs.

### SUMMARY OF THE INVENTION

It is therefore an object of the present invention to provide a method for cleaning an ink jet imaging device that reduces the amount of wasted ink and reduces the total maintenance time. Such object is obtained by the method in accordance with claim 1.

In a method according to the present invention, nozzles which normally are refreshed easily (i.e. having a shorter ink path) are actuated. The pressure waves induced by the actuation will limit the flow through those nozzles and by that will increase the flow, and with it the refreshment rate of the nozzle whose refreshment rate is normally lower, i.e. which nozzles are located more downstream of the common ink supply channel. Important is to only start jetting when ink drops have already formed on the nozzle plate.

The actuation pulses applied to an actuator, e.g. a piezo-electric actuator or a thermo-resistor in a thermal print head, in accordance with a method according to the present invention acts as a break to the ink flow through ink channels with a shorter ink path. The pressure wave generated due to the actuation counteracts the pressure applied to the main ink supply channel. Hence the local pressure in the ink channel is reduced and hence the ink flow through that particular ink channel is reduced.

In an embodiment, the ink jet imaging device comprises a plurality of ink channels each comprising a pressure chamber fluidly connected to a nozzle; and an actuator associated with the pressure chamber, each ink channel being in fluid connection with the main ink supply channel and defining an ink path from the entrance side of the main ink supply channel to the respective nozzles, each ink path of the plurality of ink channels having a different length, and the method comprises the steps of:
a) purging ink through the plurality of ink channels by applying a pressure on the entrance side of the main ink supply channel;
b) simultaneously to step a) actuating each ink channel by applying an actuation pulse to each actuator wherein the actuation pulse provides a pressure wave in each ink channel that counteracts the local pressure in each channel, such that the flow through each ink channel is reduced, the actuation pulses applied to each of the piezo-electric actuators are selected such that the flow reduction decreases with the length of the respective ink paths in a gradual way.

In an embodiment, the actuator is selected from the group consisting of a piezo-electric actuator and a thermo-resistor.

In an embodiment, the main ink supply channel comprises two entry sides arranged at opposite sides of one another and wherein step a) of the method is performed by applying the same pressure at both entrance sides.

In an embodiment, the actuation pulse comprises an electric signal that is applied to the actuator and creates a pressure wave in the ink channel, wherein the frequency of the pressure wave is between 0.5 and 1.5 times the resonance frequency of the ink channel, preferably between 0.6 and 1.4 times the resonance frequency of the ink channel, more preferably between 0.7 and 1.3 times the resonance frequency of the ink channel, more preferably between 0.8 and 1.2 times the resonance frequency of the ink channel, more preferably between 0.9 and 1.1 times the resonance frequency of the ink channel and even more preferably between 0.95 and 1.05 times the resonance frequency of the ink channel. It is most preferred that the frequency of the generated pressure wave is at or near the resonance frequency of the ink channel. The closer the frequency of the generated pressure (acoustic) wave is to the resonance frequency of the ink channel, the more effective the counteraction of the generated acoustic wave on the purge pressure is, hence the more effective the purge flow through the actuated ink channel is reduced.

The shape of the actuation pulse is arbitrary and the design thereof is known to the skilled person. Determination of the resonance frequency (also known as the natural frequency or Eigen frequency, i.e. the frequency at which a system tends to oscillate in the absence of any driving of damping force) of ink channels can be done in various ways known to the skilled person. In case of a piezo-electric actuator, the actuator can be used as a sensor after actuation. A residual pressure wave in the ink channel can be detected and analyzed to determine the resonance frequency of that particular ink channel. Alternatively, the resonance frequency can be determined by applying a variety of actuation pulses (sequentially) to the actuator and measure the droplet velocity of the droplets expelled from the respective actuated nozzle. The resonance frequency of the ink channel can be determined from the pulse that provides droplets with maximum speed.

Dependent on the type of actuator and type of controller, the actuation pulse may be a voltage pulse or an electric current pulse.

In an embodiment, the plurality of ink channels comprised in the ink jet imaging device are actuated with a plurality of actuation pulses creating a plurality of pressure waves in the plurality of ink channels, wherein the frequency of each of the plurality of pressure waves is between 0.5 and 1.5 times the resonance frequency of the ink channel being actuated, preferably between 0.6 and 1.4 times the resonance frequency of the ink channel being actuated, more preferably between 0.7 and 1.3 times the resonance frequency of the ink channel being actuated, more preferably between 0.8 and 1.2 times the resonance frequency of the ink channel being actuated, more preferably between 0.9 and 1.1 times the resonance frequency of the ink channel being actuated and even more preferably between 0.95 and 1.05 times the resonance frequency of the ink channel being actuated. It is most preferred that the frequency of the generated pressure wave is at or near the resonance frequency of the ink channel being actuated.

In this particular embodiment, different actuation pulses for each of the plurality of ink channels may exist.

In practice (e.g. due to limitations in electronic drive components) it is impossible to apply a plurality of different pulses to the plurality of different ink channels. In extreme cases only one pulse (shape) is available for actuating all ink channels. The total purge time and used ink volume cannot be fully optimized.

Therefore, in an embodiment, an actuation pulse is selected that provides a pressure wave in the ink channel having the shortest ink path (i.e. closest to the feed side of the main ink supply channel), the pressure wave having a frequency of between 0.5 and 1.5 times the resonance frequency of the ink channel having the shortest ink path, preferably between 0.6 and 1.4 times the resonance frequency of the ink channel having the shortest ink path, more preferably between 0.7 and 1.3 times the resonance frequency of the ink channel having the shortest ink path, more preferably between 0.8 and 1.2 times the resonance frequency of the ink channel having the shortest ink path, more preferably between 0.9 and 1.1 times the resonance frequency of the ink channel having the shortest ink path, even more preferably between 0.95 and 1.05 times the resonance frequency of the ink channel having the shortest ink path and most preferably the pressure wave has a frequency at or near the resonance frequency of the ink channel having the shortest ink path; the actuation pulse being applied to the plurality of ink channels in accordance with a bitmap comprising a pattern wherein the actuation frequency of the plurality of ink channels gradually decreases with increasing ink path length.

In other words, the purge flow through an ink channel having a longer ink path is less restricted than the purge flow through ink channels having a shorter ink path, by actuating said ink channels with a similar actuation pulse in a different actuation frequency.

Combinations of the above described embodiments are within the scope of the present invention, e.g. a limited number of pulses (e.g. three standard implemented actuation pulses of a commercial print head) may be applied to the plurality of ink channels in accordance with a bitmap comprising a pattern of actuation frequencies of the plurality of ink channels.

### BRIEF DESCRIPTION OF THE DRAWINGS

For a more complete understanding of the invention and the advantages thereof, exemplary embodiments of the invention are explained in more detail in the following description with reference to the accompanying drawing figures, in which like reference characters designate like parts and in which:

FIG. 1A Schematic representation of an inkjet imaging device comprising a double nozzle row and a two-sided feed to the main ink supply channel;

FIG. 1B Schematic representation of an inkjet imaging device comprising a double nozzle row and a one-sided feed to the main in supply channel;

FIG. 1C Schematic representation of an inkjet imaging device according to FIG. 1B showing an ink path length gradient, represented by a bundle double arrows indicated with C;

FIG. 2 Schematic representation of an inkjet imaging device comprising a cascade of elements;

FIG. 3A-FIG. 3C Graphs representing the working of the method according to the present invention calculated of an array of 5 nozzles: A) volumetric flow through the nozzles, qᵢ; B) volumetric flow through the main ink supply channel from a nozzle to the next nozzle, Qᵢ; and C) the refresh time of the individual nozzles, Vᵢ/qᵢ;

### DETAILED DESCRIPTION

Due to print head geometry ink channel length differences exist, resulting in faster arriving of fresh ink to specific “first fed” portions of the print head, while other “last fed” portions fresh ink arrives much later. The invention improves the First-In-First-Out refreshment of the last fed portions by suppression of the flow from the first fed portions during purging of the print head.

Using the jetting mechanism while pressing out a large amount of ink reduces the ink flow through the actuated ink channel, as the acoustic pressure counters flushing pressure.

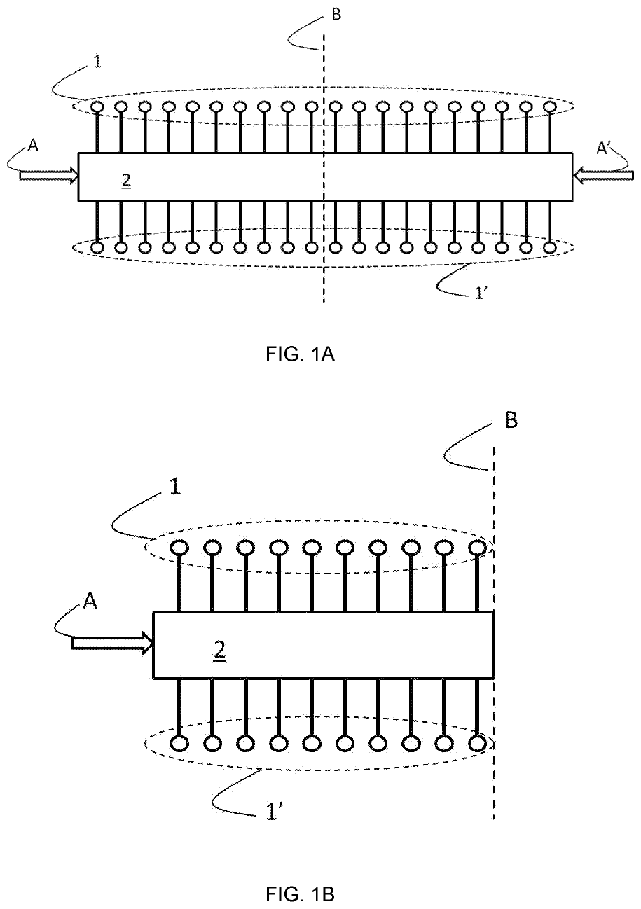

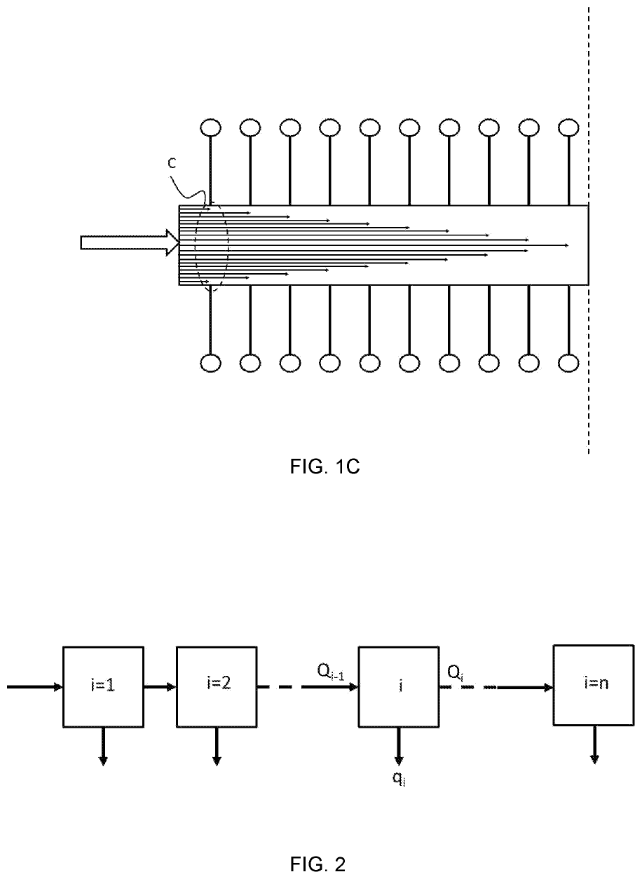

FIG. 1A shows a schematic representation of a double nozzle array (1 and 1′) and a common ink supply channel (2). The nozzles are arranged equidistantly from one another and in fluid communication with a main ink supply channel. FIG. 1A further shows an ink feed flow from both sides during a purge action, indicated with arrows A and A′. Assumed that the feed flows from both sides are equal, the feed flows meet in the center of the supply channel, creating a symmetrical situation, indicated with intermitted line B.

FIG. 1B shows half of the nozzle arrays of FIG. 1A, which also represents a one side feed situation with a dead-end side (at intermitted line indicated with B) at the opposite side of the feed side of the supply channel (arrow A).

FIG. 1C shows a schematic representation of the ink path lengths to all nozzles, indicated with a bundle of arrows indicated with C.

For the remainder of the detailed description of the present invention a single nozzle row with a dead end side will be used, which is considered representative for all other possible embodiments.

Without wanting to be bound to any theory, it is assumed that the ink supply channel consists of a bundle of ink paths to all individual nozzles, as indicated with the bundle of arrows C in FIG. 1C. It is further assumed (for principle explanation) that the flow of ink through ink channels and in particular through ink channels during a purging action is a laminar flow following Poisseuille's law:

Δpᵢ=8*pμ/(π*R⁴)*Lᵢ*qᵢ equation 1

wherein:
Δpᵢ is the pressure difference across an individual ink path (the i-th path), in Pa;
μ is the dynamic viscosity of the flowing liquid, e.g. the dynamic viscosity of the ink, in Pa*s;
R is a geometrical parameter of the channel representing the geometry of the channel in radial direction (i.e. perpendicular to the flow direction), for ideal cylindrical channels R is the channel radius (for other cross sectional shapes an equivalent radius, also termed hydraulic radius, can be empirically determined in accordance with methods disclosed in the state of the art), in m;
Lᵢ is the length of an individual ink path (the i-th path), in m;
qᵢis the volumetric flow rate through each individual ink channel, i.e. ink path (the i-th ink path), in m³/s.

In normal purge operation, the pressure difference is equal for all ink channels, it is the feed pressure, p_{feed} minus the ambient pressure outside the nozzle openings, p₀, hence Δpᵢ=Δp=p_{feed}-p₀ for all nozzles, thus a constant. In assumption that the equivalent radius, R is substantially equal for all ink paths, and with the knowledge that the lengths of the ink paths follows the gradient as shown in FIG. 1C, equation 1 can be rewritten as follows:

qᵢ=(π*R⁴*Δp)/(8*μ)*1/Lᵢ=C₁*1/Lᵢ equation 2

wherein:
qᵢ, R, Δp, μ and Lᵢ have above indicated meaning; and
C₁ is a constant, in m⁴/s.

Equation 2 indicates that the purge flow through a single ink channel is proportional to 1/Lᵢ: the flow decreases with increasing length. Besides this effect, longer ink paths have a larger volume. Therefore it takes longer to refresh all in longer ink channels.

In ideal situations (leading to shortest possible purge time and smallest amount of ink waste due to purging) the volume of an ink path should be flushed only once. The time to realize that, i.e. the shortest required purge time, is:

t_{purge,i}=Vi/qᵢ=(π*R²*Lᵢ)/(C₁*1/Lᵢ)=C₂*Lᵢ² equation 3

wherein:
t_{purge,I} is the time required to flush an ink path such that all ink present in the ink path is completely refreshed, in s;
Vᵢ=the volume of an ink path, which equals π*R²*Lᵢ, in m³;
qᵢ, R, C₁ and Lᵢ have above indicated meaning; and
C₂ is a constant, in s/m².

In the current schematic approximation, the required purge time increases with the squared length of the ink path.

So in order to thoroughly flush all ink channels, the ink channel with the longest ink path is leading. As an example, for an array of 100 equidistant nozzles, L₁₀₀ is approximately 100 times L₁, therefore t_{purge,100} is approximately 10000 times t_{purge,} 1, which means during thorough purging the nozzle closest to the feed end side of the ink supply channel is flushed way in excess, leading to unnecessary and undesired ink waste.

The present invention provides a solution for at least partially solving above described problem. For explanation purposes, a different representation is used, as shown in FIG. 2. FIG. 2 shows a schematic representation of an array of nozzles fluidly connected to a common ink supply channel. This representation comprises a cascade of elements (i=1 . . . n), each element representing a single nozzle. For each cascade element a mass balance can be made, which basically indicates that the inflowing mass minus the outflowing mass equals the accumulation of mass in a cascade element. In steady state and due to incompressibility of the liquid in an element (constant liquid density), the accumulation in each element equals zero. Hence, the combined incoming volumetric flows in a cascade element are equal to the combined exiting volumetric flows in the cascade element. In a mathematical representation, the mass balance is represented by equation 4:

Qᵢ₋₁=Qᵢ+qᵢ equation 4

wherein:
Qᵢ₋₁ is the incoming volumetric flow in the i-th cascade element (which is equal to the outflowing volumetric flow of the (i-1)-th cascade element which is in fluid connection with the i-th cascade element as shown in FIG. 2), in m³/s;
Qᵢ, is the exiting volumetric flow through the common ink supply channel from the i-th cascade element to next cascade element, in m³/s; and
qᵢ is the exiting volumetric flow from the i-th cascade element through the i-th nozzle opening, in m³/s

From equation 2 it is deduced that in a standard purging operation (i.e. applying a pressure to the entrance side of the ink supply channel), the volumetric flows through the nozzles (qᵢ) is only determined by the length of the particular channel, due to the fact that the pressure drop across all channels (Δpᵢ) is equal for all nozzles (Δpᵢ). This means that the flow in the main supply channel rapidly decreases in the direction of the volumetric flow (i.e. downstream the main supply channel.

Qᵢ=Qᵢ₋₁-qᵢ=Qᵢ₋₁-C₁*1/Lᵢ equation 5

wherein all parameters have above indicated meanings.

The pressure drop in the main supply channel is therefore largest near the feed entrance side, in accordance with equation 2.

In order to obtain a more linear and smaller pressure drop across the common ink supply channel the present invention provides a method to reduce the ink flow through ink channels with shorter ink paths, i.e. located near the ink feed side of the common ink supply channel, more particular, the method provides a possibility to apply a gradient of counteracting pressures across the nozzle array.

The actuation pulse shape is not particularly limited as long as it creates a pressure wave in the ink channel being actuated that is on or near the resonance frequency of the ink channel being actuated (actually, the electric signal is applied to the actuator that creates a pressure wave in liquid present in the associated pressure chamber, the pressure wave advances through the liquid present in the ink channel). Such actuation pulses pinch (i.e. reduce, limit) the ink flow through the actuated ink channel.

By applying such pulses, the local pressure (i.e. pressure near the nozzle opening) may be counteracted and the purge flow through a nozzle may be restricted. In accordance with the mass balance presented in equation 4, the flow to the next cascade element (i.e. to the next nozzle) is increased. By suppressing the flow through the next nozzle in a similar way a more balanced required purge time (t_{purge,i}) can be obtained, leading to a shorter required flush time, because flow downstream the common ink supply channel decreases much less (i.e. more liquid left to flush downstream located ink paths), hence the total used purge volume is much lower.

In an embodiment, the present invention provides a gradient of actuation pulses across the nozzle array (i.e. different actuation pulse per nozzle) in order to obtain a gradient of counteracting pressure waves across the nozzle array during a purging action, leading to a more evenly distributed (in view of equation 3) nozzle purge times, resulting in optimized (shorter) total purge time and hence less ink waste.

Exact calculation of parameters requires iterative calculation and numeric methods. This is not included in the present disclosure.

Schematic descriptions of models are only used for principle explanation. Graphical representation of flows and pressures do not reflect exact values in a real operative situation but are for illustrative purposes only.

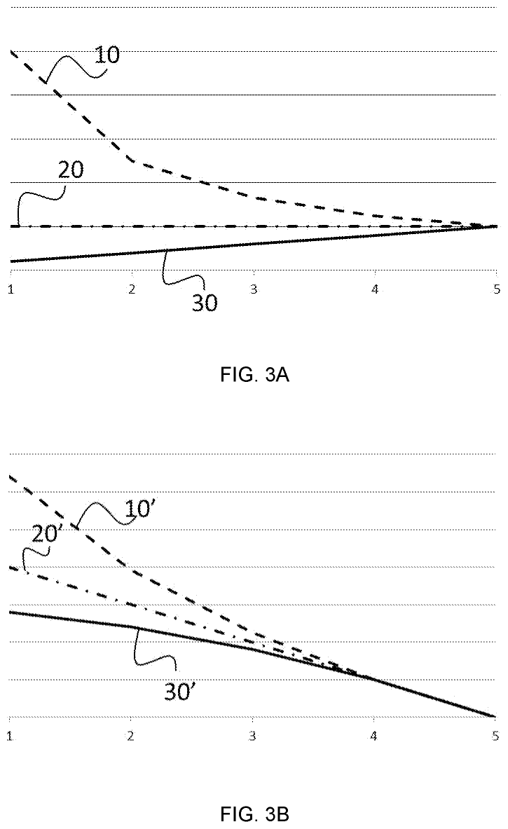

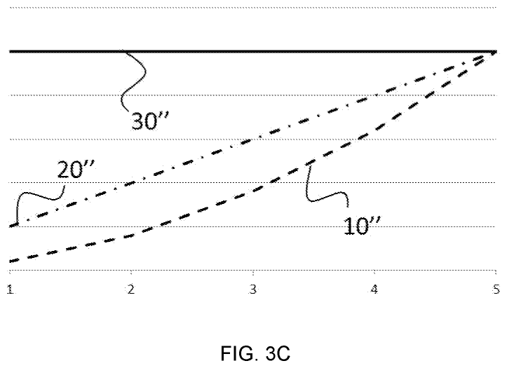

FIG. 3 shows a schematic representation of the effect of the present invention. Graph A in FIG. 3 shows the volumetric flow through each ink channel (qᵢ as represented by equation 2) in an exemplary array of 5 nozzles. The scale on the y-axes is an arbitrary scale. The mere purpose of the graphs shown in FIG. 3 are to explain the present invention and do not represent an actual nozzle array. The graphs indicate trends. For the flow through the ink channels, qᵢ, three situations are shown in graph A in FIG. 3: 1) curve 10 indicates the decay in flow through the ink channel with increasing ink path length in a steady state situation applying a purge pressure to the entrance side without applying actuation pulses to the respective actuators to counteract the local pressure and hence reducing the flow through one or more nozzles (x-axis indicates i, the number of the nozzle, where i=1 represents the nozzle closest to the entrance side of the main ink supply channel and i=5 represents the nozzle the farthest from the entrance side of the main ink supply channel); 2) curve 20 indicates a situation where actuation pulses are applied to the nozzles such that the flow through the ink channels is equalized, which is an improvement with regards to the first situation (the accumulated flows through the ink channels are smaller than the accumulation of the flows through the ink channels when no actuations are performed; and 3) curve 30 represents a situation where the refresh time for all ink channels is equal (see also graph C of FIG. 3). The flow through ink channels having a shorter in path length is smaller than the ink flow through channels having a longer ink path length.

As a consequence of the ink flow through the nozzles as shown in graph A of FIG. 3, the remaining ink flow to the next nozzle can be calculated with the mass balance given in equations 4 and 5. Graph B of FIG. 3 shows the same situations as shown in Graph A: 1) curve 10′ shows that due to higher flows through ink channels with a shorter ink path (when no actuations are used) rapidly decreases, leaving less volumetric flow for the remaining nozzles; 2) curve 20′ shows a less steep decline in flow to the next nozzles when the flow through all nozzles is equal; and 3) curve 30′ shows an even less steep decline in flow to the next nozzles when the flows through the nozzles is optimized such that the refresh time for each nozzle is equalized. Finally, graph C of FIG. 3 shows the refresh rate of each nozzle (i.e. the volume of the nozzle divided by the volumetric flow through that nozzle). Again the above described three situations are represented: 1) curve 10″ shows the largest difference in refresh rate between the first (i=1) and the last (i=5 in this particular example|) nozzles; 2) for equal flows through each nozzle, the refresh rate is linear (curve 20′), the first nozzle has the shortest refresh time and the last nozzle the longest; and 3) curve 30″ indicates the situation wherein the actuation pulses for each individual nozzle are optimized such (a gradient) that the refresh times (hence refresh rates) are equal for all nozzles. This represents an ideal situation, because this situation represents the situation leading to the minimum ink waste.

The above examples are theoretical and approximations based on the equations and assumptions made in the above description but indicate that by suppressing ink flow through ink channels with a shorter ink path during purging provides shorter purge times and less total required purge volume and hence (much) less ink waste.

It is further noted that in the description above the terminology “flow through a nozzle” and “flow through an ink channel” are both used to indicate the same parameter, qᵢ. In this approximation, the flow out of a nozzle is equal to the flow through an ink channel associated to that particular nozzle.

In practice, both the total purge time and the total purge volume can be optimized in this way, leading to shorter maintenance times (shorter down times, hence increase of productivity) and less ink waste (or maintenance liquid, or any other jetting liquid).

It is noted that the pulse shape is largely dependent on the acoustic design of the ink channels and may therefore have many shapes. The present invention relates to counteracting local pressure for limiting ink flow through a particular nozzle during purging. Suitable counteracting actuation pulse shapes are arbitrary and can be determined by a skilled person based on knowledge regarding the particular acoustic design of the nozzle array whereto the invention is applied.

1. A method for cleaning an ink jet imaging device, the ink jet imaging device comprising a main ink supply channel comprising an entrance side for supplying ink, a first ink channel comprising a first pressure chamber fluidly connected to a first nozzle; and a first actuator associated with the first pressure chamber, the first ink channel being in fluid connection with the main ink supply channel and defining a first ink path from the entrance side of the main ink supply channel to the first nozzle and having a first length L1, the ink jet imaging device comprising a second ink channel comprising a second pressure chamber fluidly connected to a second nozzle; and a second actuator associated with the second pressure chamber, the second ink channel being in fluid connection with the main ink supply channel and defining a second ink path from the entrance side of the main ink supply channel to the second nozzle and having a second length L2, wherein L2>L1; the method comprising the steps of:
a) purging ink through the first and the second nozzle by applying a pressure on the entrance side of the main ink supply channel;
b) simultaneously to step a) actuating the first ink channel by applying a first actuation pulse to the first actuator wherein the actuation pulse provides a pressure wave in the first ink channel that counteracts the local pressure in the first ink channel, such that the flow through the first ink channel is reduced during purging.

2. The method of claim 1 wherein the ink jet imaging device comprises a plurality of ink channels each comprising a pressure chamber fluidly connected to a nozzle; and a actuator associated with the pressure chamber, each ink channel being in fluid connection with the main ink supply channel and defining an ink path from the entrance side of the main ink supply channel to the respective nozzles, each ink path of the plurality of ink channels having a different length, characterized in that the method comprises the steps of:
a) purging ink through the plurality of ink channels by applying a pressure on the entrance side of the main ink supply channel;
b) simultaneously to step a) actuating each ink channel by applying an actuation pulse to each actuator wherein the actuation pulse provides a pressure wave in each ink channel that counteracts the local pressure in each channel, such that the flow through each nozzle is reduced, the actuation pulses applied to each of the actuators are selected such that the flow reduction decreases with the length of the respective ink paths in a gradual way.

3. The method according to claim 1, wherein the actuator is selected from the group consisting of a piezo-electric actuator and a thermo-resistor.

4. The method according to claim 1, wherein the main ink supply channel comprises two entry sides arranged at opposite sides of one another and wherein step a is performed by applying the same pressure at both entrance sides.

5. The method according to claim 1, wherein the actuation pulse comprises an electric signal that is applied to the actuator and creates a pressure wave in the ink channel, wherein the frequency of the pressure wave is in a range of between 0.5 and 1.5 times the resonance frequency of the ink channel

6. The method according to claim 1, wherein an actuation pulse is selected that provides a pressure wave in the ink channel having the shortest ink path, the pressure wave having a frequency in a range of between 0.5 and 1.5 times the resonance frequency of the ink channel having the shortest ink path; the actuation pulse being applied to the plurality of ink channels in accordance with a bitmap comprising a pattern wherein the actuation frequency of the plurality of ink channels gradually decreases with increasing ink path length.

7. The method according to claim 2, wherein the actuator is selected from the group consisting of a piezo-electric actuator and a thermo-resistor.

8. The method according to claim 2, wherein the main ink supply channel comprises two entry sides arranged at opposite sides of one another and wherein step a is performed by applying the same pressure at both entrance sides.

9. The method according to claim 2, wherein the actuation pulse comprises an electric signal that is applied to the actuator and creates a pressure wave in the ink channel, wherein the frequency of the pressure wave is in a range of between 0.5 and 1.5 times the resonance frequency of the ink channel

10. The method according to claim 2, wherein the plurality of ink channels comprised in the ink jet imaging device are actuated with a plurality of actuation pulses creating a plurality of pressure waves in the plurality of ink channels, wherein the frequency of each of the plurality of pressure waves is in a range of between 0.5 and 1.5 times the resonance frequency of the ink channel being actuated.

11. The method according to claim 2, wherein an actuation pulse is selected that provides a pressure wave in the ink channel having the shortest ink path, the pressure wave having a frequency in a range of between 0.5 and 1.5 times the resonance frequency of the ink channel having the shortest ink path; the actuation pulse being applied to the plurality of ink channels in accordance with a bitmap comprising a pattern wherein the actuation frequency of the plurality of ink channels gradually decreases with increasing ink path length.
